(19) United States
(12) Patent Application Publication
(10) Pub. No.: US 2016/0243808 A1
(43) Pub. Date: Aug. 25, 2016

(54) NANOFIBER INTERLAMINAR LAYER FOR CERAMIC MATRIX COMPOSITES

(71) Applicant: United Technologies Corporation, Hartford, CT (US)

(72) Inventor: Wayde R. Schmidt, Pomfret Center, CT (US)

(21) Appl. No.: 14/628,600

(22) Filed: Feb. 23, 2015

(51) Int. Cl. B32B 38/08; B32B 18/00

(52) U.S. Cl. CPC B32B 38/08; B32B 18/00; B32B 2262/105

(57) ABSTRACT

A component according to an example embodiment of the present disclosure includes first and second layers, the first and second layers each including ceramic-based fibers arranged in a ceramic-based matrix material, and nanofibers arranged between the first and second layers. An alternate component and a method of forming a component are also disclosed.

### BACKGROUND

Composite materials, such as ceramic matrix composites (CMCs), can be utilized in high-temperature applications. CMCs may have multiple layers of fibers that are disposed in a ceramic matrix. For example, fiber layers are stacked and then infiltrated with a ceramic material to form the matrix.

### SUMMARY

A component according to an example embodiment of the present disclosure includes first and second layers, the first and second layers each including ceramic-based fibers arranged in a ceramic-based matrix material, and nanofibers arranged between the first and second layers.

In another example according to previous embodiment, the nanofibers include at least one of a carbide, a nitride, an oxycarbide, an oxynitride, a carbonitride, a silicate, a boride, a phosphide, and an oxide.

In another example according to any of the previous embodiments, the nanofibers are silicon carbide nanofibers.

In another example according to any of the previous embodiments, the nanofibers have diameters between approximately 10 and 500 nanometers and the nanofibers have lengths between approximately 50 and 1,000,000 nanometers.

In another example according to any of the previous embodiments, a ratio of the amount of ceramic-based fibers to the amount of nanofibers by volume fraction is between 1.5% and 280%.

In another example according to any of the previous embodiments, the nanofibers cover greater than approximately 20% of a surface area of the first layer.

In another example according to any of the previous embodiments, the nanofibers have a random orientation with respect to one another.

In another example according to any of the previous embodiments, the nanofibers have a unidirectional orientation.

A component according to an example embodiment of the present disclosure includes a plurality of layers, each layer of the plurality of layers including a first plurality of fibers arranged in a ceramic-based matrix material, the first plurality of fibers being ceramic-based fibers, and a second plurality of fibers disposed exclusively at interlaminar regions between each of the plurality of layers, the second plurality of fibers being nanofibers.

In another example according to any of the previous embodiments, the nanofibers include at least one of a carbide, a nitride, an oxycarbide, an oxynitride, a carbonitride, a silicate, a boride, a phosphide, and an oxide.

In another example according to any of the previous embodiments, the nanofibers have diameters between approximately 10 and 500 nanometers and the nanofibers have lengths between approximately 50 and 1,000,000 nanometers.

In another example according to any of the previous embodiments, a ratio of the amount of ceramic-based fibers to the amount of nanofibers by volume fraction is between 1.5% and 280%.

In another example according to any of the previous embodiments, the nanofibers cover greater than approximately 20% of a surface area of the first layer.

A method of forming a component according to an example embodiment of the present disclosure includes depositing nanofibers onto at least one of first and second layers, the first and second layers each including ceramic-based fibers arranged in a ceramic-based matrix material, and bonding the first and second layers and the nanofibers to form a component.

In another example according to any of the previous embodiments, the method further comprises arranging the first and second layers in an alternating manner with the nanofibers.

In another example according to any of the previous embodiments, subsequent the depositing step, the nanofibers in the third layer cover greater than approximately 20% of a surface area of the first or second layers.

In another example according to any of the previous embodiments, the depositing step includes depositing nanofibers directly onto at least one of the first and second layers.

In another example according to any of the previous embodiments, the depositing step includes electrospinning or centrifugal spinning.

In another example according to any of the previous embodiments, the depositing step includes forming a fibrous mat of nanofibers independent of the first and second layers and applying the mat to at least one of the first and second layers.

In another example according to any of the previous embodiments, the method further comprises densifying the component by at least one of chemical vapor infiltration, preceramic polymer infiltration (PIP), and glass transfer molding (GTM).

These and other features may be best understood from the following drawings and specification.

### BRIEF DESCRIPTION OF THE DRAWINGS

FIG. 1A schematically shows a ceramic matrix composite component.

FIG. 1B schematically shows a cross-section of the composite component of FIG. 1A.

FIG. 1C schematically shows a cross-section of an alternate composite component.

FIG. 2 shows a method of forming a ceramic matrix composite component.

### DETAILED DESCRIPTION

Ceramic matrix composite (CMC) materials can include multiple layers or ‘plies’ of ceramic-based fibers that are disposed in a ceramic-based matrix. The layers are bonded together along interlaminar regions. The strength of this bond is known as the “interlaminar strength.” If the interlaminar strength is insufficient in certain applications, “delamination” can occur, whereby the layers come apart from one another. One way to improve interlaminar strength is to increase the surface area of the bond between layers in the interlaminar region. One way to increase surface area available for bonding is to increase surface roughness. In that regard, the CMC component disclosed herein includes nanofibers deposited in the interlaminar region.

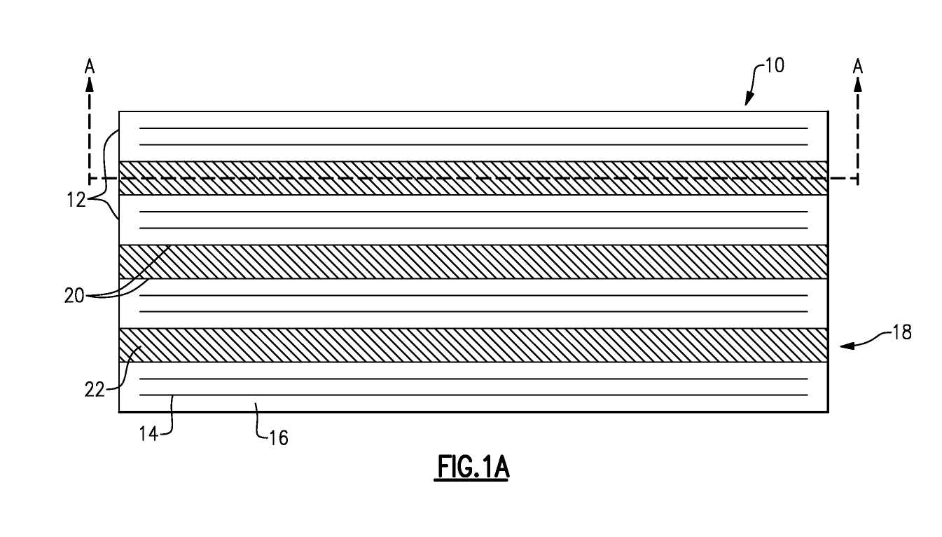

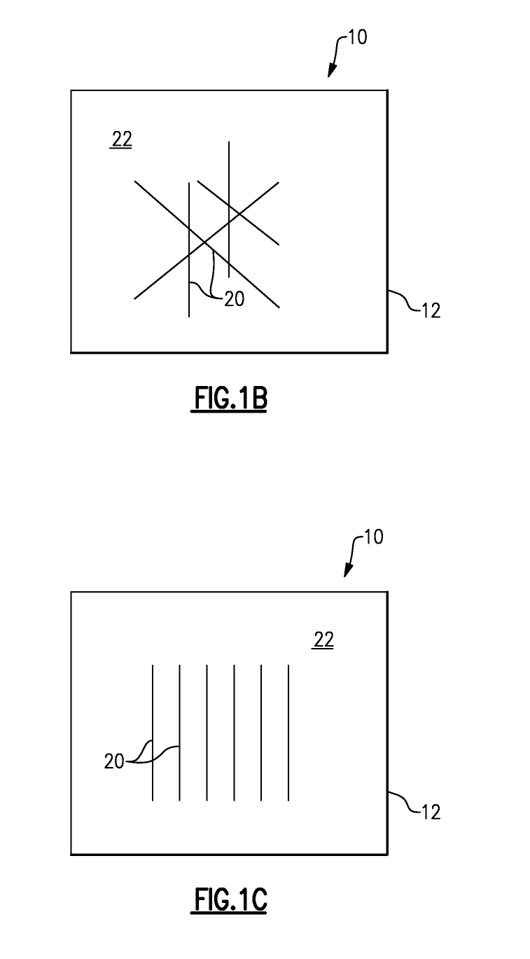

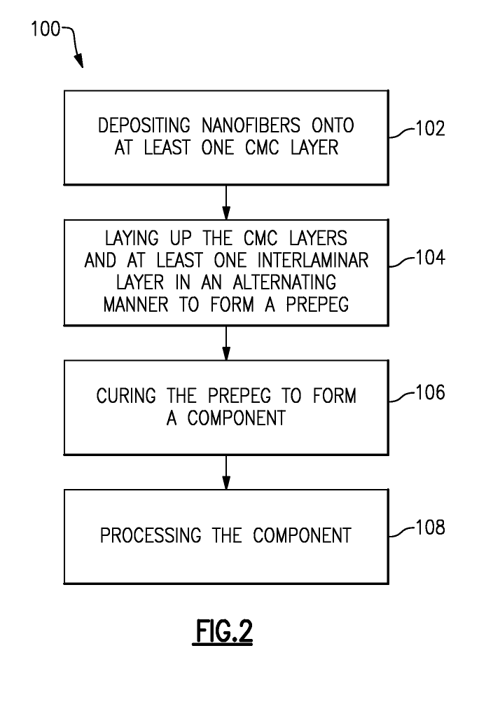

FIG. 1A shows a CMC component 10. FIG. 1B schematically shows a cross-section of the component 10 along the line A-A. Although the component 10 is depicted with a generic shape, it is to be understood that the component can be formed in a desired geometry, such as but not limited to a gas turbine engine airfoil, blade, vane, or seal. However, the present disclosure is not limited to engine articles and the examples herein can also be applied to other articles that are used in high-temperature environments, either in stationary or motion (i.e. rotational) applications.

The component 10 includes layers 12. Each of the layers 12 includes ceramic-based fibers 14 in a ceramic-based matrix material 16. The matrix material 16 can be, for example, a polymer-derived ceramic material. The layers 12 meet at an interlaminar interface 18. The interlaminar interface 18 includes nanofibers 20. The nanofibers 20 are deposited onto surfaces 22 of the CMC layers 12. In one example, the diameter of the nanofibers 20 is between approximately 10 and 500 nanometers and the length of the nanofibers 20 is between approximately 50 and 1,000,000 nanometers.

The nanofibers 20 are nonwoven and can be arranged, for example, in a random orientation, as is shown in FIG. 1B. In another example, nanofibers 20 are predominantly aligned in one or more unidirectional orientations, as is shown schematically in FIG. 1C. The nanofibers 20 cover a fraction of a surface area of the CMC layer 12. In one example, the fraction is greater than approximately 20%.

In further examples, the nanofibers 20 are carbide-, nitride-, oxycarbide-, oxynitride-, carbonitride-, silicate-, boride-, phosphide-, or oxide-based fibers. In still further examples, the fibers are fully crystalline, partially crystalline or predominantly amorphous or glassy. In one particular example, the nanofibers 20 are silicon carbide fibers.

In a further example, the amount of the nanofibers 20 and fibers 14 are controlled relative to one another to promote interlaminar adhesion. For example, a ceramic matrix composite would preferably have a volume fraction of fibers 14 in the composite of between 15% and 70%, whereas an amount of nanofibers 20 is preferably between about 0.25% and 10% by volume fraction relative to the composite. In one example, a ratio of the amount of fibers 14 in each layer to the amount of nanofibers 20 is between approximately 1.5% and 280% by [volume fraction/volume fraction]. More particularly, the ratio is between approximately 5% and 100% by [volume fraction/volume fraction].

FIG. 2 shows a method 100 of forming a ceramic matrix composite component 10. In step 102, nanofibers 20 are deposited on at least one of a plurality of CMC layers 12. That is, the nanofibers 20 are exclusively at the interlaminar region 18 adjacent surfaces 22 of the CMC layers 12 and do not infiltrate the CMC layers 12. In step 104, the plurality of CMC layers 12 are layed up to form a prepreg such that the nanofibers 20 are arranged between two of the plurality of CMC layers 12. That is, the nanofibers 20 are arranged in an alternating manner with the CMC layers 12. In step 106, the prepeg is cured to bond the CMC layers 12 and nanofibers 20 to form a CMC component 10. In optional step 108, the component is processed. For example, the component 10 is densified by a process such as chemical vapor infiltration (CVI), preceramic polymer infiltration (PIP), glass transfer molding (GTM), or another suitable method.

Prior to step 102, each of the CMC layers 12 may be prepared by, for example, arranging fibers 14 in a desired pattern and infiltrating the fiber 14 arrangement with a matrix material 16. In some examples, such as but not limited to those where polymer-derived ceramic matrix materials 16 are used, the matrix material 16 can be cured subsequent to the infiltration step to form the CMC layer 12.

In one example, nanofibers 20 can be deposited directly onto the at least one CMC layer 12, such as by electrospinning or forced spinning. In electrospinning, nanofibers 20 are drawn by applying an electrostatic charge (e.g. high voltage potential) across a gap between a solution or liquid melt containing the nanofiber precursor and the substrate upon which the nanofiber will be deposited. In forced spinning, nanofibers 20 are drawn by centrifugal force provided by spinning from either a solution or a semisolid or liquid material (as in a melt). In another example, nanofibers 20 are arranged independent of the at least one CMC layer 12 into a fibrous mat, and the fibrous mat is applied to the at least one CMC layer 12. The fibrous mat may be formed by, for example, performing the electrospinning or centrifugal spinning onto an alternate substrate that can be easily removed or from which the fibrous mat can be readily released. The nanofiber mat can be then directly placed onto the at least one CMC layer 12, or it can be processed separately, for example by thermal treatment, then directly placed onto the at least one CMC layer 12.

Regardless of the deposition method, the nanofibers can be provided in an oriented architecture by moving nanofiber deposition heads in a ‘back-and-forth’ or oscillating manner, or in a predominantly nonwoven, or random, architecture when such control methods are not used. Multilayers of oriented and random nanofiber mats are also contemplated.

In step 106, curing the prepeg bonds the CMC layers 12 together via the nanofibers 20. Nanofibers 20 increase the surface roughness (and thereby the surface area) of the CMC layers 12 available for bonding. The increased bond surface area increases the strength of the overall interlaminar bonds, which improves the strength of the CMC component 10 and mitigates delamination. The curing process can include, for example, heat and/or pressure treatment, the application of ultraviolet light or electromagnetic radiation, pyrolysis, etc., depending on the type of fibers 14, the type of matrix material 16, and the type of nanofibers 20. The curing process may also include forming the component 10 into a desired shape.

In one example, the curing step 106 can be performed in multiple steps. For instance, a first curing step can be performed subsequent to laying up the prepeg in step 104 to partially cure the prepeg. Then, the prepreg can be assembled with other prepegs to form a component 10, and a second curing step can be performed.

It should be understood that the present disclosure can be applied to other composite materials, such as but not limited to organic matrix composites (OMCs).

Although an embodiment of this invention has been disclosed, a worker of ordinary skill in this art would recognize that certain modifications would come within the scope of this disclosure. For that reason, the following claims should be studied to determine the true scope and content of this disclosure.

1. A component, comprising:
first and second layers, the first and second layers each including ceramic-based fibers arranged in a ceramic-based matrix material; and
nanofibers arranged between the first and second layers.

2. The component of claim 1, wherein the nanofibers include at least one of a carbide, a nitride, an oxycarbide, an oxynitride, a carbonitride, a silicate, a boride, a phosphide, and an oxide.

3. The component of claim 2, wherein the nanofibers are silicon carbide nanofibers.

4. The component of claim 1, wherein the nanofibers have diameters between approximately 10 and 500 nanometers and the nanofibers have lengths between approximately 50 and 1,000,000 nanometers.

5. The component of claim 1, wherein a ratio of the amount of ceramic-based fibers to the amount of nanofibers by volume fraction is between 1.5% and 280%.

6. The component of claim 1, wherein the nanofibers cover greater than approximately 20% of a surface area of the first layer.

7. The component of claim 1, wherein the nanofibers have a random orientation with respect to one another.

8. The component of claim 1, wherein the nanofibers have a unidirectional orientation.

9. A component, comprising:
a plurality of layers, each layer of the plurality of layers including a first plurality of fibers arranged in a ceramic-based matrix material, the first plurality of fibers being ceramic-based fibers; and
a second plurality of fibers disposed exclusively at interlaminar regions between each of the plurality of layers, the second plurality of fibers being nanofibers.

10. The component of claim 9, wherein the nanofibers include at least one of a carbide, a nitride, an oxycarbide, an oxynitride, a carbonitride, a silicate, a boride, a phosphide, and an oxide.

11. The component of claim 9, where in the nanofibers have diameters between approximately 10 and 500 nanometers and the nanofibers have lengths between approximately 50 and 1,000,000 nanometers.

12. The component of claim 9, wherein a ratio of the amount of ceramic-based fibers to the amount of nanofibers by volume fraction is between 1.5% and 280%.

13. The component of claim 9, wherein the nanofibers cover greater than approximately 20% of a surface area of the first layer.

14. A method of forming a component, comprising:
depositing nanofibers onto at least one of first and second layers, the first and second layers each including ceramic-based fibers arranged in a ceramic-based matrix material; and
bonding the first and second layers and the nanofibers to form a component.

15. The method of claim 14, further comprising arranging the first and second layers in an alternating manner with the nanofibers.

16. The method of claim 14, wherein subsequent the depositing step, the nanofibers in the third layer cover greater than approximately 20% of a surface area of the first or second layers.

17. The method of claim 14, wherein the depositing step includes depositing nanofibers directly onto at least one of the first and second layers.

18. The method of claim 17, wherein the depositing step includes electrospinning or centrifugal spinning.

19. The method of claim 14, wherein the depositing step includes forming a fibrous mat of nanofibers independent of the first and second layers and applying the mat to at least one of the first and second layers.

20. The method of claim 14, further comprising densifying the component by at least one of chemical vapor infiltration, preceramic polymer infiltration (PIP), and glass transfer molding (GTM).
